(19) United States
(12) Patent Application Publication
(10) Pub. No.: US 2012/0199074 A1
(43) Pub. Date: Aug. 9, 2012

(54) MULTI-LAYER PET BED

(76) Inventor: Wonjung Song, Richmond, CA (US)

(21) Appl. No.: 13/021,339

(22) Filed: Feb. 4, 2011

(51) Int. Cl. A01K 1/035; A01K 29/00

(52) U.S. Cl. 119/28.5

(57) ABSTRACT

A pet bed having an upper fabric layer, lower fabric layer and a peripheral edge joining the upper and lower fabric layers defining the shape of the pet bed. Proximate the upper fabric layer is located a casing, the casing enclosing chopped memory foam and proximate the lower fabric layer is located sheet of open cell foam having an undulating surface next to the lower fabric layer such that the undulating surface creates dimples on said lower fabric layer.

### TECHNICAL FIELD

The present invention involves a bedding product which is ideally suited for use as a pet bed Pet beds of this type are ideally suited for use by dogs appreciative of a pet bed which provides differing surfaces facilitating lounging and sleeping while also providing a therapeutic foundation.

### BACKGROUND OF THE INVENTION

It is quite common to provide a pet bed particularly for a dog as an alternative to the dog sleeping and lounging on a hard or thinly carpeted surface. As dogs grow older, they tend to spend more time sleeping and lounging while, at the same time, oftentimes must cope with arthritic and similar debilitating conditions. Many pet owners are insensitive to a dog's needs and as most dogs do not express their discomfort, they continue to silently suffer as they attempt to sleep and lounge.

It is thus an object of the present invention to provide a bedding product which provides two unique surfaces to accommodate a dog.

A further object of the present invention is to provide a bedding product suitable for pets of all ages and which is particularly suitable for older dogs and those suffering from arthritis.

These and further objects will be more readily apparent when considering the following disclosure and appended claims.

### SUMMARY OF THE INVENTION

A pet bed having an upper fabric layer, lower fabric layer and a peripheral edge joining the upper and lower fabric layers defining the shape of the pet bed. Proximate the upper fabric layer is located a casing, the casing enclosing chopped memory foam and proximate the lower fabric layer is located sheet of open cell foam having an undulating surface such that the undulating surface creates dimples on said lower fabric layer.

### BRIEF DESCRIPTION OF THE FIGURES

FIG. 1 is a perspective view of the pet bed of the present invention with its upper fabric layer being visible thereon.

FIG. 2 is a cross sectional view taken along line 2-2 of FIG. 1.

FIG. 3 is perspective view of the pet bed of the present invention with the lower fabric layer being visible thereon.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

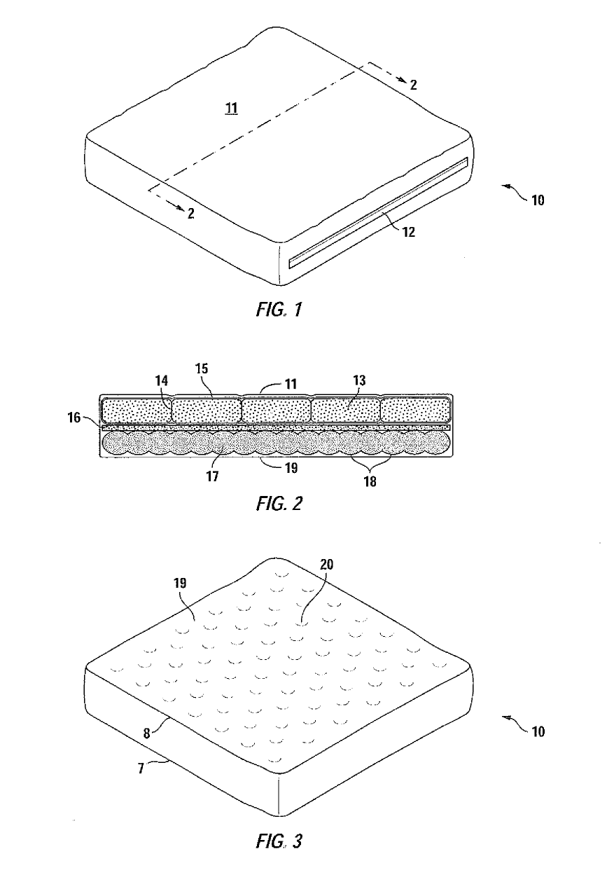

Turning to FIG. 1, pet bed 10 is illustrated showing upper fabric layer 11. As noted by reference to FIG. 2, upper fabric layer 11 resides over casing 15 which encloses chopped memory foam 13 Stitching or barriers 14 can be applied to casing 15 for segregating portions of the memory foam to prevent its migration within the casing. Such a configuration is taught in U.S. Pat. No. 7,353,773 owned by the present applicant, the disclosure of which is incorporated by reference herein.

Memory foam 13 contained within casing 15 creates a thick, therapeutic foundation encouraging sleep. Thus, pet bed 10 comprised of upper fabric 11 and lower fabric 19 (FIG. 3) creating peripheral edges 7 and 8 defines the shape of pet bed 10 as shown.

In referring once again to FIG. 2, it is noted that proximate lower fabric layer 19 is located a sheet of open cell foam 17 having an undulating surface 18 such that said undulating surface creates dimples 20 on said lower fabric layer 19. These dimples ease painful pressure points and cushions achy joints and muscles making lower fabric layer 19 especially ideal for aging or arthritic dogs.

To summarize, the present pet bed is ideally suited for all pets and particularly pet dogs. Younger dogs which do not have arthritic or achy joints may prefer to reside on upper fabric layer 11 for engaging reclaimed memory foam 13 for establishing a therapeutic foundation for sleep. As the pet ages or as the present pet bed is introduced to a pet having arthritis or other pain& conditions, bed 10 can be turned over exposing lower fabric layer 19 to enable dimples 20 to engage the pet in order to ease its painful pressure points and cushion achy joints and muscles.

Pet bed 10 can also include selectively closable seem 12 in order to enable subparts within bed 10 to be removed for cleaning and replacement. In this regard, it is noted in reference to FIG. 2 that pet bed 10 can also include liner 16 separating casing 15 from foam layer 17 to enhance the structural correctness of this pet bed product.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like.

Therefore, the above description and illustration should not be considered as limiting the scope of the invention, which is defined by the appended claims.

1. A pet bed comprising an upper fabric layer, lower fabric layer and a peripheral edge joining said upper and lower fabric layers defining the shape of said pet bed, proximate said upper fabric layer is located a casing, said casing enclosing chopped memory foam and proximate said lower fabric layer is located a sheet of open cell foam having an undulating surface next to said lower fabric layer such that said undulating surface creates dimples on said lower fabric layer.

2. The pet bed of claim 1 wherein a portion of said peripheral edge is selectively closable to promote an opening for gaining access to the interior of said pet bed.

3. The pet bed of claim 1 wherein stitching or barriers are applied to said casing for segregating portions of said enclosed chopped memory foam into separate compartments.

4. The pet bed of claim 1 wherein a liner is incorporated therein between said casing and said sheet of open cell foam.

5. The pet bed of claim 1 wherein said pet bed can reside upon a horizontal surface with either said upper fabric layer or lower fabric layer in contact with said surface to present the lower fabric layer and upper fabric layer, respectively, as the surface to receive a pet for lounging thereon.
